(19) United States
(12) Patent Application Publication
(10) Pub. No.: US 2026/0098598 A1
(43) Pub. Date: Apr. 9, 2026

(54) UNIVERSAL QUICK-CONNECT HOSE KIT

(71) Applicants: Mitch Saccoccio, Hays, NC (US); Jonathan Bonelli, New York, NY (US)

(72) Inventors: Mitch Saccoccio, Hays, NC (US); Jonathan Bonelli, New York, NY (US)

(21) Appl. No.: 18/908,983

(22) Filed: Oct. 8, 2024

(51) Int. Cl. F16L 15/00

(52) U.S. Cl. CPC F16L 15/007; F16L 15/008; F16L 19/02; F16L 19/0231; F16L 25/14; F16L 27/1008; F16L 33/223; F16L 47/04

(57) ABSTRACT

A universal quick-connect hose kit for a fluid system includes an adapter configured for coupling to the fluid system, a flexible hose for coupling to the adapter, and union nuts mounted on respective ends of the flexible hose, The union nuts are each arranged to rotatably couple the adapter to a respective end of the flexible hose.

### BACKGROUND OF THE INVENTION

The present invention is directed to a kit which provides secure coupling of a hose to an adapter in a fluid system, without need to resort to hose clamps which are prone to leaking and difficult to work with and secure. The present kit makes installation and removal of hoses in a fluid system very easy and virtually eliminates leaks. At the same time, the kit allows coupling of hoses to any variety of size and shape adapters.

### SUMMARY OF THE INVENTION

Accordingly, it is an object of the present invention to improve coupling of a hose in a fluid system.

It is a more specific object of the present invention to expedite coupling of a hose in a fluid system.

It is an additional object of the present invention to improve ease of coupling a hose in a fluid system.

It is another object of the present invention to avoid leakage upon coupling a hose in a fluid system.

It is a further object of the present invention to improve versatility in coupling hoses in different fluid systems.

It is yet a further object of the present invention to minimize number of components required to couple a hose in a fluid system.

These and other objects are explicitly attained by the present invention, which is directed to a universal quick-connect hose kit having an adapter configured for coupling to a fluid system, a flexible hose, and union nuts mounted on respective ends of the flexible hose. The union nuts are each arranged to rotatably couple the adapter to a respective end of the flexible hose.

Most manufacturers design their fluid systems for only proprietary coupling. In contrast, the present kit converts any such proprietary coupling thread to a standard thread for coupling, greatly increasing versatility. The universal kit of the present invention is adaptable to convert filters which use standard hose clamps, to eliminate need for such clamps. In this regard, the present kit is adaptable to any hose connection, and eliminates need for a hose clamp.

Eliminating existing hoses and clamps by using the present kit, prevents leakage and failure of couplings. Unwanted trips to obtain replacement parts upon such failure, are eliminated with the present kit. Furthermore, the present kit is easy to retrofit onto existing coupling systems.

### BRIEF DESCRIPTION OF THE DRAWINGS

The present invention will be described in greater detail with reference to the accompanying drawings, in which

FIG. 1 is an exploded view of the components forming the kit according to the present invention,

FIG. 2 is a perspective view of the assembled hose, cuffs and union nuts forming part of the kit,

FIG. 3 is a closeup view of an end of the hose included in the kit and showing the union nut rotatably retained on the end thereof, and

FIG. 4 is a top plan view of a package containing the components forming the kit for assembly and use in coupling.

### DESCRIPTION OF THE PREFERRED EMBODIMENTS

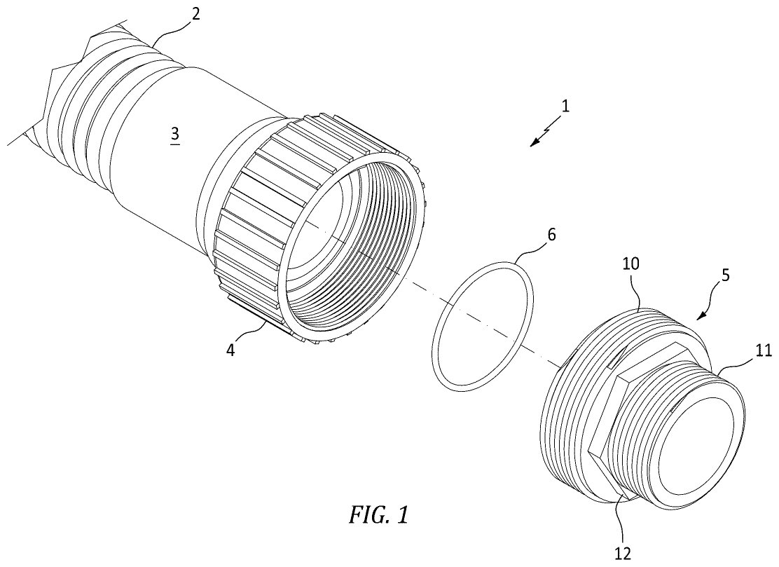

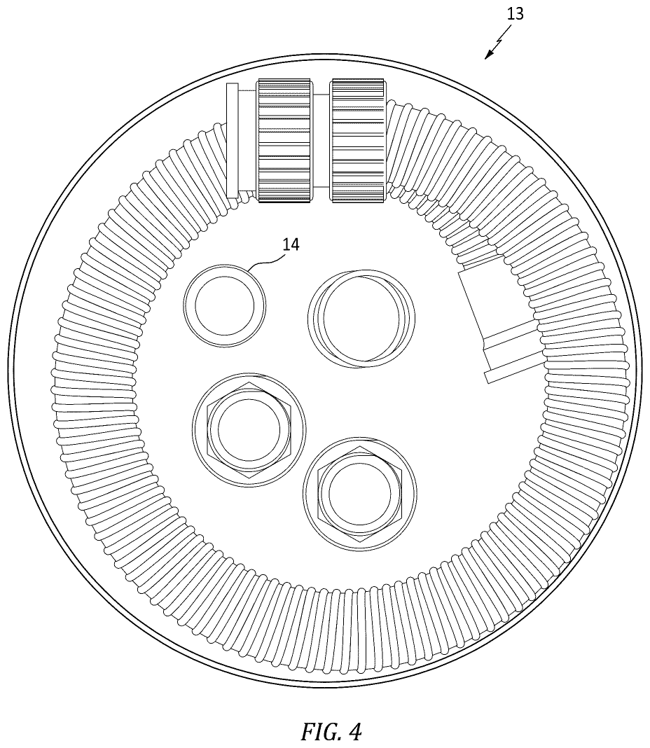

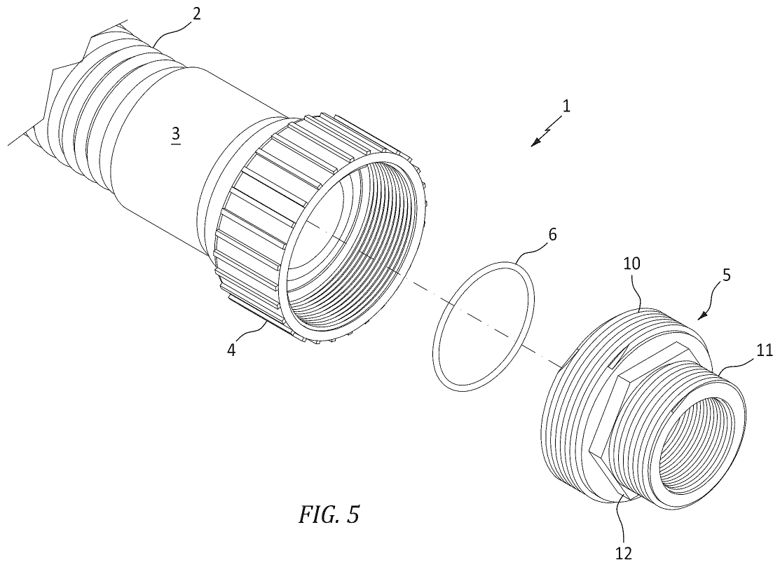

Referring to the drawings, the kit 1 of the present invention includes a flexible hose 2 having cuffs 3 affixed to opposite ends thereof, and union nuts 4 rotatably retained on the opposite ends of the hose 2. An adapter 5 is provided to couple the end of the hose 2 to a fluid system. Additionally, an O-ring 6 is provided for fluid-tight coupling between the adapter 5 and hose end as shown, e.g., in FIG. 1. As shown in FIG. 4, the kit 1 can be arranged in cylindrical packaging 13, with two adapters 5 and O-rings 6 for securing the opposite ends of the hose 5, along with thread-seal tape 14.

The union nuts 4 rotatably mounted upon the respective ends of the hose 2, are each threadedly coupled onto a threaded end 10 of a respective adapter 6, with the O-ring or flat gasket 6 compressed therebetween to prevent leakage (FIG. 1). The union nut 4 compresses the O-ring 6 when screwed onto the adapter 5. Additionally, the thread-seal tape 14 is wound around the respective threads on adapter end 11 to ensure fluid-tight coupling when the adapter end 11 is screwed into a fluid system port.

The adapter 5 has two opposite ends 10, 11 of different diameters, both externally threaded, and with a hexagonally-shaped step 12 situated therebetween (FIG. 1). The smaller end 11 of the adapter 5 is configured to fit any end of any fluid system. Preferably, a whole number of differently-sized adapters 5 for accommodating different fluid systems are included in the kit 1. The intermediate hexagonal step 12 allows tightening with a wrench after the hose 2 is coupled to respective ports of a fluid system, thereby preventing leakage.

For example, the smaller end 11 of the adapter 5 can fit on and be secured to a return, a pump inlet, a discharge outlet, or a skimmer. Preferably, the smaller open end of the adapter 5 fits a conventional 1½ inch diameter opening, although the adapter 5 can be designed to fit any size opening, e.g., a 1.25 inch opening. Several differently sized adapters 5 configured to fit and couple to any number of differently sized fluid inlets or outlets can be provided in the kit 1, the only requirement being the adapter 5 securely couples to the respective union nut 4 of the hose 2.

More particularly, the outer dimension of the adapter 5 is designed to couple to the inner diameter of the union nut 4. One advantage is the adapter 5 can be molded to fit any sized opening, with either male or female threads. For example, the adapter 5 can be molded, preferably injection-molded from a variety of materials such as ABS, polypropylene, polyethylene, polyurethane, etc.

Alternatively, the adapter 5 can be provided with female threads, and the union nut 4 with male threads for rotative coupling. In the illustrated embodiment, the stepped ends 10, 11 of the adapter 5 are both provided with external threads. However, one of these stepped ends 10, 11 can be internally-threaded instead, e.g., stepped end 11.

The hexagonally-shaped intermediate step 12 is provided on the adapter 5 for tightening after coupling, to ensure there is no leakage upon fluid flow. In this regard, the kit 1 including the adapter 5 can be used with a multiport pump disclosed, e.g., in U.S. Pat. No. 11,536,044 and explicitly improves over the kit disclosed in this patent, notably the adapter.

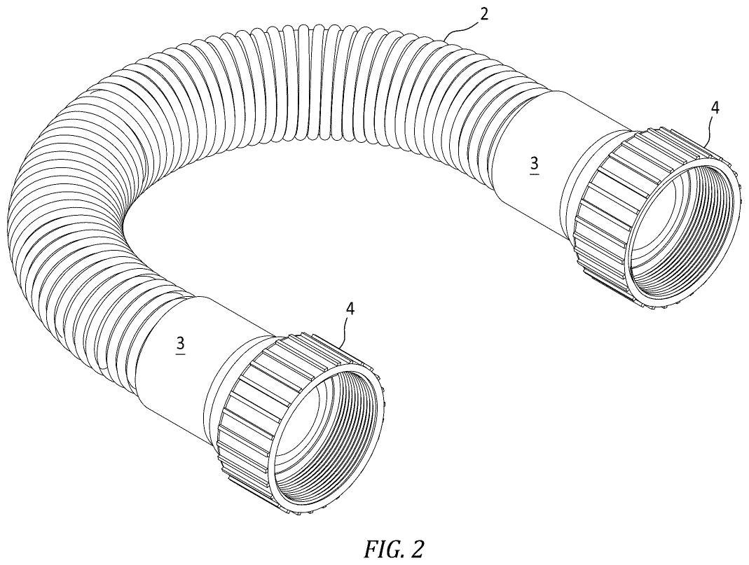

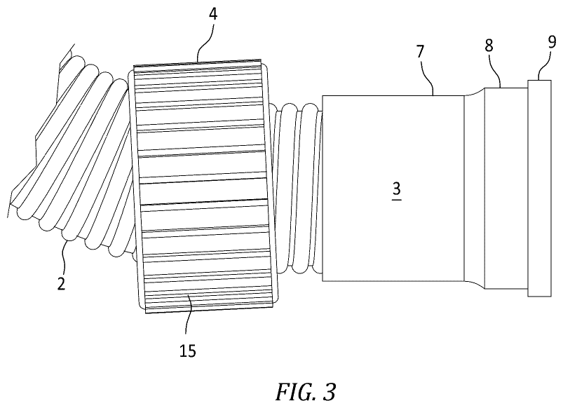

The hose 2, which has a flexible, spiral or accordion-shaped length, has two union nuts 4 each rotatably mounted and retained on opposite ends thereof, as shown, e.g., in FIG. 2. Any length hose 2 can be included in the kit 1 of the present invention. More specifically, as shown in FIG. 3, the union nut 4 is rotatably mounted on a bell-shaped cuff 3 secured to each end of the hose 2, so the union nut 4 cannot be pulled off the end of the hose 2 but, at the same time, can be rotatably threaded onto an adapter 2. Fin-like ridges 15 are provided along the outer surface of the union nut 4 to facilitate gripping and rotating.

In particular, the cuffs 3 each have three cylindrically-shaped steps 7, 8, 9, with a largest 9 of these cylindrically-shaped steps 7, 8, 9 situated at an open end of the hose 2. The union nuts 4 respectively mounted on the cuffs 3 each have an internal diameter smaller than an external diameter of the respective largest step 9 of the cuff 3, so that the union nut 4 is rotatably retained upon the respective cuff 3.

The cuff 3 on the end of the hose 2 can also be made by injection molding, and is permanently attached to the end of the hose 2 by gluing, spin-welding, or screwing. The material for making the cuff 3 can be PVC and the union nut 4 can be ABS.

The kit 1 of the present invention not only versatilely fits and couples to a variety of fluid openings of different shapes and dimensions, but also eliminates need for hose clamps to circumferentially secure the coupling of the hose to the fluid opening, because the adapter 5 can be securely tightened to the respective union nut 4 to seal the connection against any fluid leakage, e.g., by tightening with a wrench.

The preceding description of the present invention is merely exemplary and not intended to limit the scope thereof in any way.

1. A universal quick-connect hose kit, comprising:
an adapter configured for coupling to a fluid system,
a flexible hose, and
union nuts mounted on respective ends of said flexible hose,
with said union nuts each arranged to rotatably couple said adapter to a respective end of said flexible hose, wherein said adapter comprises two externally-threaded steps of different diameter.

2. The kit of claim 1, comprising two said adapters each configured to be coupled to a respective end of said flexible hose.

3. The kit of claim 1, wherein said hose comprises cuffs affixed to opposite ends of said hose, and
said union nuts are rotatably retained on each said cuff to allow rotative coupling to a respective adapter.

4. The kit of claim 1, wherein said adapter comprises external threads, and each said union nut comprises internal threads, to allow said adapter and respective union nut to be threaded together.

5. The kit of claim 4, additionally comprising an O-ring or flat gasket arranged to be situated between said adapter and respective union nut when threaded together.

6. The kit of claim 3, wherein said hose comprises accordion bends along a length thereof.

7. The kit of claim 3, wherein said cuffs each comprise three cylindrically-shaped steps, with a largest of said cylindrically-shaped steps situated at an end opening of said hose, and
said union nuts respectively mounted on said cuffs each comprise an end having an internal diameter smaller than an external diameter of said respective largest step such that said union nut is rotatably retained upon said respective cuff for rotative coupling to the adapter.

8. (canceled)

9. The kit of claim 8, wherein said adapter additionally has a hexagonally-shaped step between said threaded steps of different diameter.

10. An adapter configured for coupling to a hose, comprising two outer steps of different external diameter, and
an intermediate step having an external diameter between the different external diameters of the outer steps, wherein the step having a smaller external diameter is internally-threaded.

11. The adapter of claim 10, wherein the steps are each externally-threaded.

12. (canceled)

13. The adapter of claim 10, wherein said intermediate step has a hexagonally-shaped outer diameter.

14. A hose configured for coupling to a fluid system, comprising cuffs affixed to opposite ends of said hose, and
union nuts each rotatably retained on a respective end of said hose, and an adapter that comprises two externally-threaded steps of different diameter.

15. The hose of claim 14, wherein said union nuts are each internally threaded.

16. The hose of claim 14, wherein said cuffs each comprise three cylindrically-shaped steps, with a largest of said cylindrically-shaped steps situated at an open end of said hose, and
said union nuts respectively mounted on said cuffs each comprise an internal diameter smaller than an external diameter of said respective largest step such that said union nut is rotatably retained upon said respective cuff.

17. The hose of claim 14, wherein said hose is corrugated.
